(19) United States
(12) Patent Application Publication
(10) Pub. No.: US 2023/0366979 A1
(43) Pub. Date: Nov. 16, 2023

(54) Uplink Signaling and Receive Beamforming for Dual-Function Radar Communications

(71) Applicant: Government of the United States, as represented by the Secretary of the Air Force, Wright-Patterson AFB, OH (US)

(72) Inventors: Aboulnasr Hassanien, Beavercreek, OH (US); Cenk Sahin, Beavercreek, OH (US); Justin Metcalf, Dayton, OH (US); Braham Himed, Dayton, OH (US)

(21) Appl. No.: 18/198,350

(22) Filed: May 17, 2023

Related U.S. Application Data
(63) Continuation of application No. 16/781,012, filed on Feb. 4, 2020, now abandoned.
(60) Provisional application No. 62/801,824, filed on Feb. 6, 2019.

(51) Int. Cl. G01S 7/00; H04B 7/0413; G01S 7/292

(52) U.S. Cl. CPC G01S 7/006; H04B 7/0413; G01S 7/2921

(57) ABSTRACT

A communication system, method and computer program product enable transmitting information via the same spectrum as a multiple-input multiple-output (MIMO) radar using the same spectrum. First, a radar system conducts a search mode using a MIMO radar waveform. Second, an uplink communications transmitter employs a new type of signaling that allows the radar to search for targets in the spatial direction of the communication transmitter. Specifically, the MIMO radar can conduct a search task while receiving data from a communication transmitter using the same frequency allocation without blinding the MIMO radar in the direction of the target.

### CROSS-REFERENCE TO RELATED APPLICATIONS

This application is a continuation of U.S. patent application Ser. No. 16/781,012 filed Feb. 4, 2020, which claims the benefit of priority under 35 U.S.C. § 119(e) to U.S. Provisional Application Ser. No. 62/801,824 filed Feb. 6, 2019, the contents of which are incorporated herein by reference in their entirety.

### ORIGIN OF THE INVENTION

The invention described herein was made by employees of the United States Government and may be manufactured and used by or for the Government of the United States of America for governmental purposes without the payment of any royalties thereon or therefore.

### BACKGROUND

### 1. Technical Field

The present disclosure generally relates to testing apparatus and methods of performing radar terrain mapping by an airborne platform, and more particularly to performing radar terrain mapping by an airborne platform that also communicates with ground transmitters.

### 2. Description of the Related Art

Airborne platforms such as military aircraft often incorporate large terrain mapping radar systems for purposes of low altitude flight navigation and target acquisition. For example, attack and bomber aircraft can have a nose mounted radar system that has an ideal vantage point to survey the ground along the path of the aircraft. In certain real-time engagement scenarios, the airborne platform needs to identify targets and coordinate an attack with friendly assets in close proximity to the targets. To communicate with these friendly assets, other communication systems on the airborne platform are used, often which have to be a less convenient vantage point on the airframe. In addition, significant efforts have to be employed so that the radar and communication systems do not interfere with each other. For example, a multiple-input multiple-output (MIMO) radar either is limited in the time slots in which it can operate relative to a particular area of the ground transmitter. As a further alternative, the MIMO radar is blind in the direction of the ground transmitter.

### BRIEF SUMMARY

According to aspects of the present disclosure, a dual-function radar communications (DFRC) system includes more than one antenna, a multiple input multiple output (MIMO) radar system communicatively coupled to the more than one antenna, and at least one MIMO communications system communicatively coupled to the more than one antenna. A controller of the DFRC system is communicatively coupled to the MIMO radar system and the at least one MIMO communications system. The controller executes program code to enable the DFRC system to transmit, via the MIMO radar system, a set of pseudo-orthogonal waveforms. The controller executes program code to enable the DFRC system to transmit, via the at least one MIMO communications system, at least one communication uplink data-stream, occupying bandwidth used by the MIMO radar system. Each of the at least one communication uplink data-stream have a unique spatial steering vector orthogonal to any radar targets of interest. The controller executes program code to enable the DFRC system to receive a return signal, via the more than one antenna, containing returned radar echoes reflected from targets and at least one communication uplink signal. The controller executes program code to enable the DFRC system to separate the returned radar echoes from the at least one communication uplink signal using spatial diversity.

According to aspects of the present disclosure, a method enables receiving radar returns and uplink communications using a DFRC system. The method includes transmitting, via a MIMO radar system communicatively coupled to the more than one antenna, a set of pseudo-orthogonal waveforms. The method includes transmitting, via one or more MIMO communications systems, at least one communication uplink data-stream, occupying bandwidth used by the MIMO radar system, each of the at least one communication uplink data-stream having a unique spatial steering vector orthogonal to any radar targets of interest. The method includes receiving a return signal, via the more than one antenna, containing returned radar echoes reflected from targets and at least one communication uplink signal. The method includes separating the returned radar echoes from the at least one communication uplink signal using spatial diversity.

The above summary contains simplifications, generalizations and omissions of detail and is not intended as a comprehensive description of the claimed subject matter but, rather, is intended to provide a brief overview of some of the functionality associated therewith. Other systems, methods, functionality, features and advantages of the claimed subject matter will be or will become apparent to one with skill in the art upon examination of the following figures and detailed written description.

### BRIEF DESCRIPTION OF THE DRAWINGS

The description of the illustrative embodiments can be read in conjunction with the accompanying figures. It will be appreciated that for simplicity and clarity of illustration, elements illustrated in the figures have not necessarily been drawn to scale. For example, the dimensions of some of the elements are exaggerated relative to other elements. Embodiments incorporating teachings of the present disclosure are shown and described with respect to the figures presented herein, in which:

FIG. 1 illustrates a diagram of uplink transmission in dual-function radar communications (DFRC) systems, according to one or more embodiments;

FIG. 2 illustrates an illustrative timing diagram of transmit/receive signaling, according to one or more embodiments;

FIG. 3 illustrates a graphical plot of overall radar beampattern and cross-interference pattern versus angle, according to one or more embodiments;

FIG. 4 illustrates a graphical plot of minimum variance distortionless response (MVDR) beampattern versus angle for radar receive beamforming as well as radar-communication cross-interference, according to one or more embodiments;

FIG. 5 is a graphical plot of signal-to-interference plus noise ratio (SINR) versus signal-to-noise ratio (SNR) with no interference, according to one or more embodiments;

FIG. 6 illustrates a block diagram for uplink signal transmission for lTp≤t≤(l+1)Tₚ, l=1, . . . , L, according to one or more embodiments;

FIG. 7 illustrates a block diagram of a MIMO radar receiver, according to one or more embodiments; and

FIG. 8 presents a flow diagram of a method for receiving radar returns and uplink communications using a dual-function radar communications (DFRC) system.

### DETAILED DESCRIPTION

Existing techniques for dual-function radar communications (DFRC) have been focused on the problem of downlink communication and information embedding into the emission of the radar system. Here, we consider the problem of half-duplex uplink communications in dual-function multiple-input multiple-output (MIMO) radar communication systems. The DFRC system consists of a dual-function platform which functions as a MIMO radar during transmit mode and simultaneously receive and process signals reflected from targets and uplink communication signals transmitted by one or more communication users. We propose a method for uplink signaling via forming a number of uplink beams carrying the same number of data symbols. Moreover, we employ non-adaptive and adaptive beamforming techniques at the radar receiver to separate the received communication signal from the target return even if they arrive from the same spatial angle. Cross-interference between the received communication and the reflected radar signals is mitigated using adaptive beamforming. We assess the effectiveness of the proposed uplink communication technique by numerical results. Without loss of generality, we assume a single communication user to more clearly explain the mathematical derivation. However, the results are valid for multiple communication users.

### I. INTRODUCTION

Spectrum sharing between radar and communications as a means to address the problem of increasingly congested radio frequency (RF) spectral environment has been the focus of intensive research [1]-[3]. Methods for radar and communications co-existence using cooperative signaling have been investigated in a number of papers [4]-[9]. The joint design of cooperative radar and communication systems has been introduced in a number of papers [10]-[13]. These techniques require that the radar and communication devices exchange information about their operation such as modulation schemes, radar waveforms, channel state information, relative spatial direction, to name a few. Exchanging such information requires establishing a wireless link between the cooperating systems.

A direct approach to alleviate competition over RF spectrum between radar and communications is to allow both systems to share the same spectrum and hardware resources and operate jointly from a single platform. The essence of this approach is to design dual-function systems that can host the communication function while carrying out the main radar function of the system. One essential requirement of these dual-function systems is the ability to implement them on existing radar platforms, i.e., they should enable upgrading existing single-function radar systems into dual-function systems. Therefore, these techniques should be designed under specific constraints and requirements dictated by the radar system and be capable of making full use of the available radar resources such as high-quality hardware, large bandwidth, and high transmit power. The emerging concept of dual-function radar communication (DFRC) has been recently introduced (see [14]; and references therein) and different signaling strategies have been proposed [15]-[23]. The aforementioned techniques considered the case of downlink data transmission via embedding information in the emission of the DFRC system. However, to the best of our knowledge, no existing work has considered the case of uplink communications where the data is transmitted from a communication user and received by a radar platform acting as a DFRC system.

We consider the problem of uplink communications in dual-function multiple-input multiple-output (MIMO) radar communication systems. We assume that the DFRC system operates as a MIMO radar during transmit mode. During receive mode, the DFRC platform simultaneously receives and processes signals reflected from targets as well as uplink signals transmitted by a communication user. We assume perfect synchronization between the DFRC system and the communication user in slow-time and fast time. We propose a method for uplink signaling via forming a number of uplink beams carrying the same number of data symbols. To be able to separate the uplink communications from the target return signals, we employ spatial diversity via enforcing the spatial signature of the uplink signals to be orthogonal to the spatial steering vectors associated with the target returns. Making use of spatial diversity, non-adaptive and adaptive beamforming techniques can be used at the DFRC receiver to separate the received communication signal from the target return even if they arrive from the same spatial angle. We show that the cross-interference between the received communication signal and the reflected radar signals can be effectively mitigated. We assess the effectiveness of the proposed uplink communication technique by numerical results.

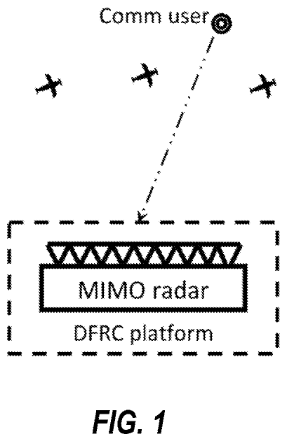

The rest of the patent description is organized as follows. In Sec. II, the system configuration and the signal model are given. The proposed uplink communication signaling scheme is given in Sec. III. Receive beamforming for radar and communications is considered in Sec. IV. Simulations results are given in Sect. V and conclusions are drawn in Sec. VI. FIG. 1 is an illustrative diagram of uplink transmission in DFRC systems.

### II. SYSTEM CONFIGURATION AND SIGNAL MODEL

This section provides the configuration for the DFRC system as well as the MIMO radar transmit and receive signal models. The overall system consists of a DFRC system with a dual function transmit-receive platform and one communication terminal, as illustrated in FIG. 1. The DFRC platform utilizes the resources of the MIMO radar, i.e., bandwidth, waveforms, power, and hardware. The MIMO radar is equipped with one arbitrary transmit array comprising M collocated antennas (assumed isotropic for the present derivation, but not necessarily so). Assume that the MIMO radar operates in a pulsed radar mode and let Tₚ and Tₛ denote the pulse width and pulse repetition interval (PRI), respectively. Then, the duty cycle of the system is given by

$${D}_{c} = \frac{{T}_{p}}{{T}_{s}} , \qquad ( 1 )$$

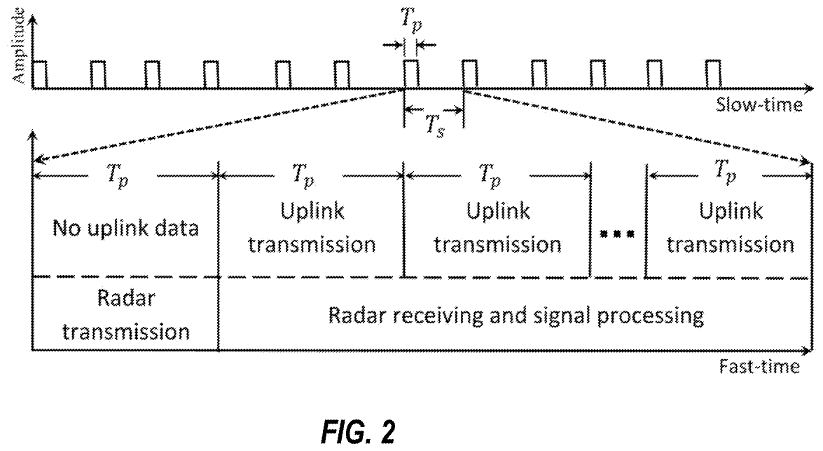

We assume that the DRFC platform and the communication user are synchronized in time and use a common analog-to-digital conversion sampling rate within each radar pulse. FIG. 2 is an illustrative diagram of transmit/receive signaling. The radar transmitting and receiving times and the time division and time interval allocation for uplink communication transmission is illustrated in FIG. 2. During transmit mode, the MIMO radar interrogates the area under surveillance by transmitting M orthogonal waveforms while the communication user remains silent. During receive time, the DFRC system receives target returns mixed with the uplink communication signal. Although other receive geometries are possible, for the present derivation we assume that the system is equipped with a linear receive array comprising N receive antennas. Without loss of generality, we assume that the same transmit array is employed as a receive array, i.e., M=N.

A. MIMO Radar Signal Model

Let ϕₘ(t), m=1, . . . , M be M independent waveforms which satisfy the orthogonality condition

∫_{T}_{ₚ}ϕₘ(t)ϕ_{m′}*(t−τ)dt=δ(m−m′),∀τ, (2)

where t is the fast time index, (⋅)* denotes the conjugate, τ is time-delay, and δ(⋅) is the Kronecker delta function. During transmit mode, the signal radiated towards a target located in a hypothetical spatial direction θ can be expressed as

r(t,θ)=a^{T}(θ)ϕ(t), (3)

where ϕ(t)=[Ø₁(t), . . . , Ø_{M}(t)]^{T} is the M×1 complex vector of orthogonal waveforms, (⋅)^{T} stands for the transpose operation,

$${a ( θ ) = {Δ}_{⩵} \vert 1 , {e}^{( j 2 π {d}_{t} sin ( θ ) )} , … , {e}^{( j 2 π {d}_{t} ( M - 1 ) sin ( θ ) )} ]}^{T} \qquad ( 4 )$$

is the M×1 steering vector of the transmit array towards the direction θ, and dₜ is the inter-element spacing between the elements of the array measured in wavelength. The N×1 complex-valued vector of the received baseband signals can be expressed as

x(t,k)=x_{radar}(t,k)+x_{com}(t,k)+xₙ(t,k), (5)

where k is the slow-time index (i.e., pulse number), x_{radar}(t, k) is the signal vector of the radar target return, x_{com}(t, k) and xₙ(t, k) are the signal vectors of the uplink communication signal and the additive noise. We assume that the noise term is white Gaussian with zero mean and covariance σ²ₙI_{N}, where I_{N} is the N×N identity matrix. Assuming that there exist J+1 targets in a certain range bin in the far field of the DFRC platform, the N×1 signal vector of the radar target return can be expressed as

$$\begin{matrix}{x}_{radar} ( t , k ) = {\sum }_{i = 0}^{J} {β}_{i} ( k ) r ( t , {θ}_{i} ) b ( {θ}_{i} ) \\ = {\sum }_{i = 0}^{J} {β}_{i} ( k ) [ {a}^{T} ( {θ}_{i} ) ϕ ( t ) ] b ( {θ}_{i} ) ,\end{matrix} \qquad ( 6 )$$

where θᵢ denotes the spatial direction associated with the i^{th} target, βᵢ (k) is reflection coefficient of the i^{th} target during the k^{th} pulse, b(θᵢ) is the N×1 steering vector of the receive array towards the direction Q_{L}.

Employing matched-filtering at the DFRC receiver, the MN×1 extended data vector associated with time delay r can be expressed as

$$\begin{matrix}y ( τ ; k ) = vec ( {\int }_{{T}_{P}} x ( t , k ) {ϕ}^{H} ( t - τ ) dt ) \\ = {y}_{radar} ( τ ; k ) + {y}_{com} ( τ ; k ) + {y}_{n} ( τ ; k ) ,\end{matrix} \qquad ( 7 )$$

where vec (⋅) denotes the vectorization operator that stacks the columns of a matrix into one long column vector, (⋅)^{H} denotes the conjugate transpose, y_{radar}(τ; k), y_{com}(τ; k) and yₙ(τ; k) are the extended signal vectors associated with the radar target return, the uplink communications, and the additive noise, respectively. The noise term yₙ (τ; k) has zero mean and covariance σ²ₙI_{MN}. The MN×1 extended complex vector of the received radar target observations can be expressed as

$$\begin{matrix}{y}_{radar} ( τ ; k ) = vec ( {\int }_{{T}_{p}} {x}_{radar} ( t . k ) {ϕ}^{H} ( t - τ ) dt ) \\ = {\sum }_{i = 0}^{J} {β}_{i} ( k ) [ a ( {θ}_{i} ) ⊗ b ( {θ}_{i} ) .\end{matrix} \qquad ( 8 )$$

Note that the waveform orthogonality condition (2) is used to obtain the extended data vectors (7) and (8). It is worth noting that, in practice, perfectly orthogonal waveforms cannot be achieved and, therefore, waveforms with low cross-correlations are used. The problem of waveform design with low cross-correlation properties has been extensively investigated in the literature (see [24]; and references therein). Here, we assume that the orthogonal MIMO radar waveforms are already designed. We also assume that the cross-correlation of the waveforms is sufficiently low and, therefore, can be neglected.

Signal processing can be applied to (7) at the DFRC receiver to extract the target and uplink communication signals while mitigating the effect of radar-communication cross-interference. This will be elaborated on later in Sec. IV.

### III. UPLINK COMMUNICATION SIGNALING

In this section, we introduce the uplink communication signal model and propose a method for constructing the uplink spatial signatures which enable eliminating or, at least, mitigating cross-interference between the radar and uplink communication signals.

Assume that during the receiving time of the DFRC system, there are L non-overlapped time intervals available for uplink signaling. In this respect, the maximum number of time intervals available depends on the ratio of the PRI Tₛ to the pulse width Tₚ, that is,

$$L \leq ⌊ \frac{{T}_{s}}{{T}_{p}} ⌋ - 1 = ⌊ \frac{1}{{D}_{c}} ⌋ - 1 \qquad ( 9 )$$

where └⋅┘ denotes the floor operator which picks the largest integer no greater than its argument. This means that the number of non-overlapped time intervals is inversely proportional to the duty cycle of the DFRC. The complex-valued baseband uplink communication signal can be modeled as

$${s}_{com} ( t , k ) = {α}_{ch} {\sum }_{l = 1}^{L} {s}_{l} ( t , k ) Δ ( t - {lT}_{p} ) , \qquad ( 10 )$$

where α_{ch} is the uplink channel coefficient which summarizes the propagation environment [symbol] between the communication user and the DFRC receiver, [symbol] (t, k) is the uplink communication signal during the [symbol] ^{th} time interval, and

$$Δ ( t ) = {Δ}_{⩵} \{ \begin{matrix}1 , 0 < t < {T}_{p} , \\ 0 , otherwise .\end{matrix} \qquad ( 11 )$$

denotes the rectangular pulse. Let [symbol] _{com} be a predesigned communication dictionary where [symbol] each element of the dictionary represents a unique communication symbol. Let [symbol] (k) ∈ [symbol] _{com}, q=1, . . . ,Q be Q uplink communication symbols that need to be transmitted during the [symbol] ^{th} time interval within the k^{th} pulse. Then, the vector of the uplink signal during the [symbol] ^{th} interval can be expressed as

$$\begin{matrix}{s}_{l} ( t , k ) = {\sum }_{q = 1}^{Q} {Ω}_{q , l} ( k ) {u}_{q}^{T} ϕ ( t ) \\ = {c}_{l}^{T} ( k ) {U}^{T} ϕ ( t ) , {lT}_{p} \leq t \leq ( l + 1 ) {T}_{p} ,\end{matrix} \qquad ( 12 )$$

where u_{q}, q=1, . . . , Q denote the uplink spatial signature associated with the q^{th} uplink communication symbol, U=[u₁, . . . , u_{Q}] is the M×Q uplink spatial signature matrix (for Q<M), and

[symbol]

(k)=[ [symbol] , . . . , [symbol] ]^{T}, [symbol] =1, . . . ,L (13)

is the Q×1 vector of the uplink communication symbols associated with the [symbol] ^{th} interval during the k^{th} pulse. At the DFRC receiver, the received N×1 vector of complex-valued baseband communication signal can be expressed as

$$\begin{matrix}{x}_{com} ( t , k ) = {\sum }_{q = 1}^{Q} {s}_{l} ( t , k ) b ( {θ}_{c} ) \\ = ( {c}_{l}^{T} ( k ) {U}^{T} ϕ ( t ) ) b ( {θ}_{c} ) , l {T}_{p} \leq t \leq ( l + 1 ) {T}_{p} ,\end{matrix} \qquad ( 14 )$$

where θ_{c} is the spatial direction of the communication user with respect to the broadside of the DFRC receive array. Noting that the uplink communication signals are transmitted within L consecutive non-overlapped intervals, the received signals can be observed by matched-filtering the x_{com}(t, k) from (14) to the orthogonal waveforms at L distinct time-delays. Specifically, the matched-filtering is performed at time-delays [symbol] = [symbol] Tₚ, [symbol] =1, . . . , L. Therefore, the MN×1 extended complex vector of the uplink communication signals at the DFRC receiver can be expressed as

$$\begin{matrix}{y}_{com}^{( l )} ( {τ}_{l} ; k ) = vec ( {\int }_{{T}_{P}} {α}_{ch} {x}_{com} ( t , k ) {ϕ}^{H} ( t - {τ}_{l} ) dt ) \\ = {α}_{ch} {\sum }_{q = 1}^{Q} {Ω}_{l , q} ( k ) [ {u}_{q} ⊗ b ( {θ}_{c} ) ] , l = 1 … , L .\end{matrix} \qquad ( 15 )$$

Based on the extended communication signal model (15), the total number of uplink communication symbols which can be transmitted towards the DFRC receiver during one radar pulse is LQ. Therefore, the uplink data rate in bit per second (bps) of the proposed uplink signaling scheme is given by

R=B·Q·L·f_{PRF} (16)

where B is the number of bits per symbol and f_{PRF} is the pulse repetition frequency (PRF). For radar applications with medium to high PRF, an uplink data rate of up to hundreds of megabits per second (Mbps) can be achieved.

As an illustrative example, consider a DFRC system operating in the x-band with PRF 100 kHz and M=32 transmit antennas. Assume that the duty cycle of the pulse is D_{c}=0.002. Then, the number of non-overlapped intervals that can be used to transmit uplink communication symbols is L=1/0.002-1=499. Assume that the number of bits per communication symbol is B=8 bits. The maximum number of symbols that can be transmitted within the same interval is Q M−1. Then, the data rate that can be achieved is R=8×31×499×10⁵=12.375 Giga-bit per second (Gbps).

### IV. RADAR AND COMMUNICATION RECEIVE BEAMFORMING

This section addresses the problem of receive beamforming and signal separation at the DFRC receiver. Two receive beamformers are introduced; one for radar target return and the other for uplink communications.

One essential requirement that the radar and communication beamformers need to achieve to enable the separation of the radar target return and the uplink communication signals with as small as possible cross-interference. To ensure that the uplink communication signal does not impair the target return when both signal components impinge on the DFRC receiver from the same spatial angle, we design the uplink spatial signature matrix U such that the following orthogonality constraint is satisfied

U^{H}a(θ_{c})=0_{M} (17)

where 0_{M} is the M×1 vector of all zeros. The orthogonality constraint (17) prevents radar-communication cross-interference from targets located in direction θ_{c}. However, this does not guarantee low cross-interference from targets located in other directions. To address this problem, we propose to construct the uplink signal spatial signature such that the spatial signatures of the extended communication signal (15) are different than the virtual steering vector of all possible targets, that is,

a(θ)⊗b(θ)≠λ·(u_{q}⊗b(θ_{c})),q=1, . . . ,Q,∀θ,λ, (18)

where λ is an arbitrary scaling factor that does not equal to zero.

We refer to the constraint (18) as the spatial diversity constraint. One solution that satisfies (18) is given by

$${u}_{q} = a ( {θ}_{c} - {ϑ}_{q} ) , {ϑ}_{q} \neq θ , \vert {θ}_{c} - {ϑ}_{q} \vert \leq \frac{π}{2} \qquad ( 19 )$$

where ∂_{q}∈[−π/2, π/2] is an arbitrary angle. The solution in (19) can be obtained by performing a one-dimensional exhaustive search for values of ∂_{q} which also satisfy (17), that is

$${\hat{v}}_{q} = {arg min}_{{v}_{q}} \vert {a}^{H} ( {θ}_{c} - {v}_{q} ) a ( {θ}_{c} ) \vert . \qquad ( 20 )$$

For the special case when the MIMO radar transmit array is a uniform linear array (ULA), values of ∂_{q} which satisfy the orthogonality constraint (17) can be obtained by solving the following equation

$$2 π {d}_{t} ( sin ( {θ}_{c} ) - sin ( ϑ ) ) = \pm k \frac{2 π}{M} , k = 1 , … , ⌊ \frac{M - 1}{2} ⌋ . \qquad ( 21 )$$

The closed-form solution to (21) is given by

$${ϑ}_{k} = {sin}^{- 1} ( sin ( {θ}_{c} \pm \frac{k}{{d}_{t} M} ) , k = 1 , … , ⌊ \frac{M - 1}{2} ⌋ . \qquad ( 22 )$$

Based on (21), there are at most M 1 spatial directions which can be used to satisfy the orthogonality constraint (17) and the spatial diversity constraint (18). Therefore, a number of Q≤M−1 uplink spatial signatures u_{q}, q=1, . . . , Q can be constructed which enable uplink transmission from communication user to the DFRC base station.

Assume that the radar target of interest is located in the spatial direction θ₀. The radar return signals can be separated from the uplink communication signal by applying beamforming techniques at the DFRC receiver. For the target of interest, the mainbeam should be focused towards the direction θ₀. Therefore, the receive beamformer for the target return is given by

$${w}_{t a r} = \frac{1}{\sqrt{MN}} [ a ( {θ}_{0} ) ⊗ b ( {θ}_{0} ) ] . \qquad ( 23 )$$

Similarly, the receive beamformer for q^{th} uplink communication symbol should form a beam towards the direction θ_{C}, that is,

$${w}_{q} = \frac{1}{\sqrt{MN}} [ {u}_{q} ⊗ b ( {θ}_{c} ) ] , q = 1 , … , Q . \qquad ( 24 )$$

Note that for the case when θ₀=θ_{C}, wₜₐᵣ and w_{q} are orthogonal to each other because of the orthogonality between u_{q} and a(θ_{C}). This enables the separation between the radar target return and the uplink signal components at the DFRC receiver, even if both signal components impinge on the receive array from the same spatial direction. Note also that, if targets located outside the main radar beam are powerful, the minimum variance distortionless response (MVDR) principle can be applied.

### V. SIMULATIONS RESULTS

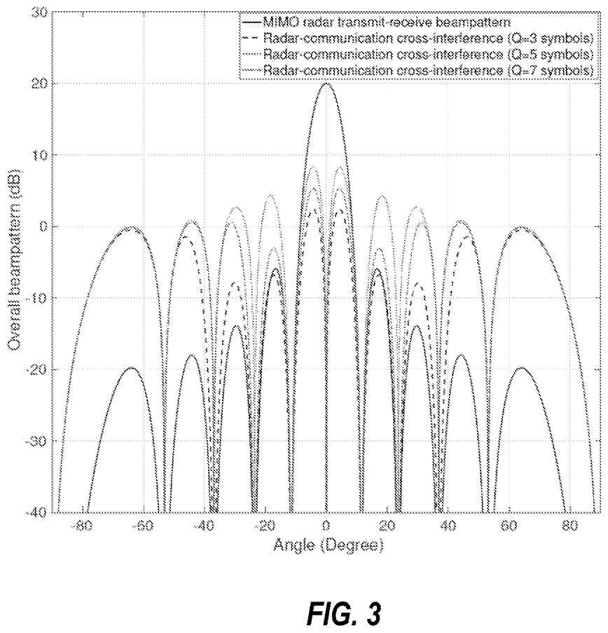

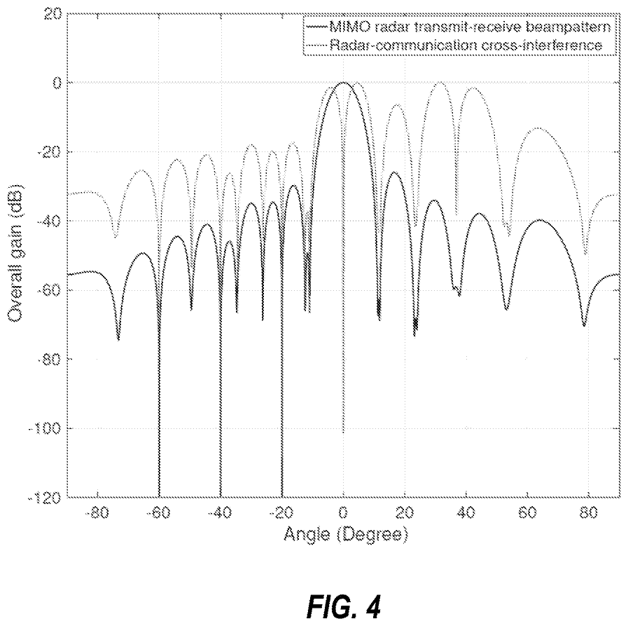

In our simulations, we consider a DFRC system comprising 10 element ULA spaced half a wavelength apart from one another. The same array is used for both transmitting and receiving. A communication user is assumed to be located in the spatial direction θ_{C}=0°. One target of interest is assumed to be located in the same direction as that of the communication user, i.e., θ₀=0°. We assume that there are three targets located in the spatial directions θ₀=−60°, θ₀=−40°, and θ₀=−20°, respectively. The communication user transmits uplink data for Q=3; 5; and 7. The spatial signatures of the uplink beams are obtaining using (17) and (19) for k=−4; −3; −2; 2; 3; 4 in addition to the choice of φ=90°. FIG. 3 shows the overall conventional transmit-receive beampattern for the MIMO radar when the mainbeam is focused towards θ₀, i.e, the target direction. The figure also shows the aggregate radar-communication cross-interference for Q=3; 5; and 7, respectively. It is clear from the figure that the cross-interference has deep null at the target direction θ₀=0°. for all values of Q. However, the cross-interference towards targets located in the sidelobe region is not sufficiently suppressed. Therefore, we use MVDR beamforming to form deep nulls towards the slidelobe target directions. FIG. 4 shows the MVDR beampattern for the target beamformer as well as for the cross-interference. The figure shows that both the radar beampattern and the cross-interference pattern have deep null towards the directions −60°, −40°, and −20°, where the sidelobe targets are located. Also, the cross-interference has deep null towards the main radar beam.

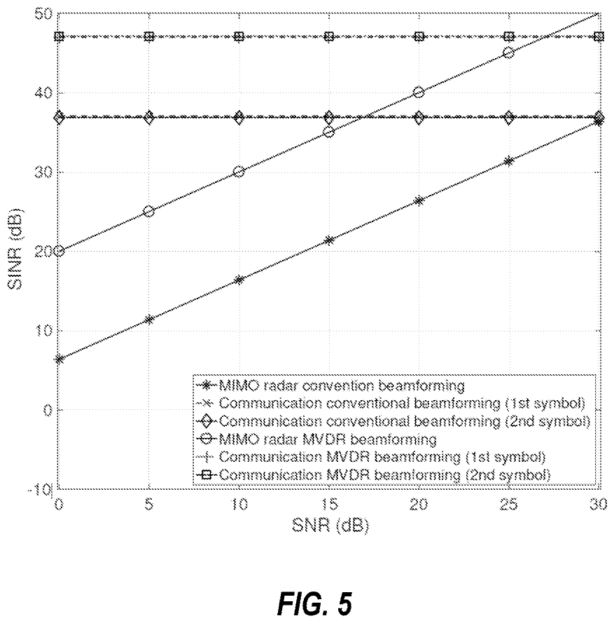

Finally, FIG. 5 shows the signal-to-interference plus noise ratio (SINR) versus signal-to-noise ratio (SNR) of the target of interest using conventional and MVDR beamforming for both radar and communications. The power of the sidelobe targets is fixed to 30 dB. The uplink communication transmits Q=2 symbols at a time with power 27 dB each. The figure shows that the MVDR beamfomer enhances the SINR for the target of interest and both communication symbols by 20 dB. On the other hand, the conventional beamformer shows an SINR loss of 12 dB as compared to the MVDR case. This can be attributed to the fact that the cross-interference has deep nulls towards the targets in the MVDR case only.

### VI. CONCLUSIONS

The problem of half-duplex uplink communications in dual-function MIMO radar communication systems was considered. A method for uplink signaling via forming a number of uplink beams carrying the same number of data symbols was proposed. The DFRC system was assumed to operate as a MIMO radar during transmit mode and dual-function receiver during receive mode. Spatial diversity was employed to enable the DFRC platform to simultaneously receive, separate, and process the uplink data and the radar target returns. Non-adaptive and adaptive beamforming techniques were employed at the radar receiver to mitigate cross-interference between the received communication signal and the radar target signals. The effectiveness of the proposed uplink communication technique was assessed by numerical results.

### REFERENCES

The following documents cited above are hereby incorporated by reference in their entirety:
[1] H. Griffiths, S. Blunt, L. Cohen, and L. Savy, “Challenge problems in spectrum engineering and waveform diversity,” in Proc. IEEE Radar Conf, April 2013, pp. 1-5.
[2] H. T. Hayvaci and B. Tavli, “Spectrum sharing in radar and wireless communication systems: A review,” in Int. Conf Electromagnetics in Advanced Applications, August 2014, pp. 810-813.
[3] H. Griffiths, L. Cohen, S. Watts, E. Mokole, C. Baker, M. Wicks, and S. Blunt, “Radar spectrum engineering and management: Technical and regulatory issues,” Proceedings of the IEEE, vol. 103, no. 1, pp. 85-102, January 2015.
[4] D. W. Bliss, “Cooperative radar and communications signaling: The estimation and information theory odd couple,” in Proc. IEEE Radar Conf, May 2014, pp. 0050-0055.
[5] A. Aubry, A. D. Maio, Y. Huang, M. Piezzo, and A. Farina, “A new radar waveform design algorithm with improved feasibility for spectral coexistence,” IEEE Trans. Aerospace and Electronic Systems, vol. 51, no. 2, pp. 1029-1038, April 2015.
[6] K.-W. Huang, M. Bica, U. Mitra, and V. Koivunen, “Radar waveform design in spectrum sharing environment: Coexistence and cognition,” in Proc. IEEE Radar Conf., May 2015, pp. 1698-1703.
[7] M. Bica and V. Koivunen, “Delay estimation method for coexisting radar and wireless communication systems,” in Radar Conference (RadarConf), 2017 IEEE. IEEE, 2017, pp. 1557-1561.
[8] F. Liu, C. Masouros, A. Li, and T. Ratnarajah, “Robust MIMO beamforming for cellular and radar coexistence,” IEEE Wireless Communications Letters, vol. 6, no. 3, pp. 374-377, June 2017.
[9] A. Martone, K. Ranney, K. Sherbondy, K. Gallagher, and S. Blunt, “Spectrum allocation for non-cooperative radar coexistence,” IEEE Transactions on Aerospace and Electronic Systems, 2017.
[10] A. Aubry, A. D. Maio, M. Piezzo, and A. Farina, “Radar waveform design in a spectrally crowded environment via nonconvex quadratic optimization,” IEEE Trans. Aerospace and Electronic Systems, vol. 50, no. 2, pp. 1138-1152, April 2014.
[11] D. Ciuonzo, A. D. Maio, G. Foglia, and M. Piezzo, “Intrapulse radar embedded communications via multiobjective optimization,” IEEE Trans. Aerospace and Electronic Systems, vol. 51, no. 4, pp. 2960-2974, October 2015.
[12] J. R. Guerci, R. M. Guerci, A. Lackpour, and D. Moskowitz, “Joint design and operation of shared spectrum access for radar and communications,” in Proc. IEEE Radar Conf, May 2015, pp. 0761-0766.
[13] B. Li, A. P. Petropulu, and W. Trappe, “Optimum co-design for spectrum sharing between matrix completion based MIMO radars and a MIMO communication system,” IEEE Trans. Signal Processing, vol. 64, no. 17, pp. 4562-4575, September 2016.
[14] A. Hassanien, B. Himed, and M. G. Amin, “Dual-function radar communications using sidelobe control,” in Radar & Communication Spectrum Sharing, S. D. Blunt and E. S. Perrins, Eds. London: IET, 2018.
[15] S. D. Blunt, M. R. Cook, and J. Stiles, “Embedding information into radar emissions via waveform implementation,” in Waveform Diversity and Design Conference (WDD), 2010 International. IEEE, 2010, pp. 195-199.
[16] J. Euziere, R. Guinvarc'h, M. Lesturgie, B. Uguen, and R. Gillard, “Dual function radar communication time-modulated array,” in Proc. IEEE Int. Radar Conf., 2014, pp. 1-4.
[17] A. Hassanien, M. G. Amin, Y. D. Zhang, and F. Ahmad, “Dual-function radar-communications: Information embedding using sidelobe control and waveform diversity,” IEEE Trans. Signal Processing, vol. 64, no. 8, pp. 2168-2181, April 2016.
[18] ______, “Phase-modulation based dual-function radar-communications,” JET Radar, Sonar Navigation, vol. 10, no. 8, pp. 1411-1421, 2016.
[19] M. Nowak, M. Wicks, Z. Zhang, and Z. Wu, “Co-designed radar communication using linear frequency modulation waveform,” IEEE Aerospace and Electronic Systems Magazine, vol. 31, no. 10, pp. 28-35, October 2016.
[20] A. Hassanien, M. G. Amin, Y. D. Zhang, and F. Ahmad, “Signaling strategies for dual-function radar communications: an overview,” IEEE Aerospace and Electronic Systems Magazine, vol. 31, no. 10, pp. 36-45, October 2016.
[21] C. Sahin, J. Jakabosky, P. M. McCormick, J. G. Metcalf, and S. D. Blunt, “A novel approach for embedding communication symbols into physical radar waveforms,” in Proc. IEEE Radar Conf., May 2017, pp. 1498-1503.
[22] P. M. McCormick, S. D. Blunt, and J. G. Metcalf, “Simultaneous radar and communications emissions from a common aperture, part I. Theory,” in Proc. IEEE Radar Conf., May 2017, pp. 1685-1690.
[23] A. Hassanien, B. Himed, and B. D. Rigling, “A dual-function MIMO radar-communications system using frequency-hopping waveforms,” in Proc. IEEE Radar Conf., May 2017, pp. 1721-1725.
[24] S. D. Blunt and E. L. Mokole, “Overview of radar waveform diversity,” IEEE Aerospace and Electronic Systems Magazine, vol. 31, no. 11, pp. 2-42, November 2016.

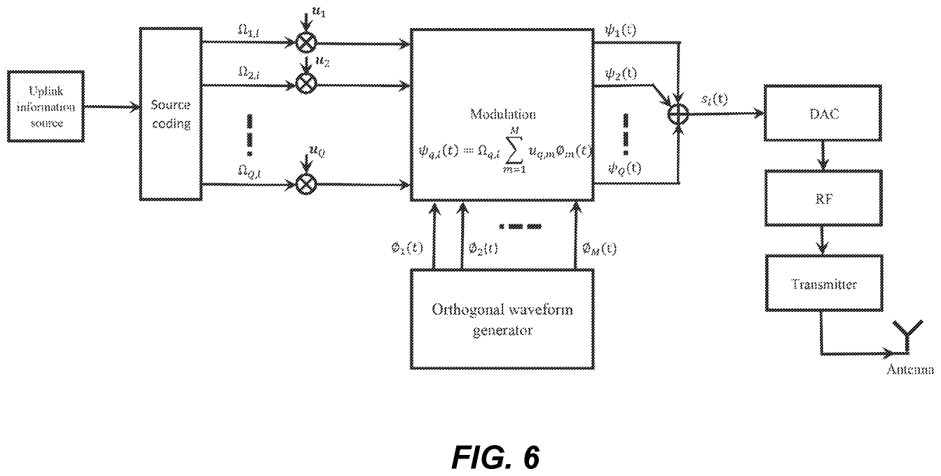

This is a new method to perform radar (primary) and communication (secondary) functions simultaneously using the same frequency spectrum. For this invention, the radar is a multiple-input multiple-output (MIMO) radar, which transmits unique orthogonal waveforms from each element. This radar is searching a large (ostensibly hemispherical) volume for targets. The communications system is at a distance from the radar in a particular direction (see FIG. 1, attached, for the system setup). The communications system wishes to transmit a series of communication packets at the time when the radar is listening for potential target echoes, as illustrated in FIG. 6. If not dealt with, the communication signal will greatly interfere with the MIMO radar performance. The solution obvious to one skilled in the art is to use the multiple channels of the MIMO radar to place a spatial null in the direction of the communications transmitter. This solution will allow for radar operation to take place but will blind the radar to the direction of the communication receiver. Therefore, this invention is a method that couples characteristics unique to a MIMO radar to remove the communications interference and still successfully search for targets in the direction of the communication transmitter (i.e. detect targets in the blind zone).

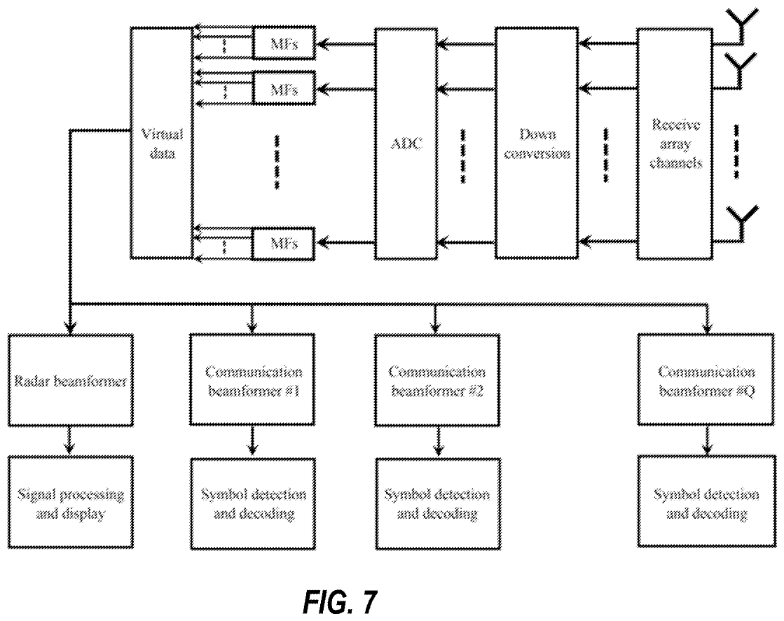

Consider a radar system that has multiple transmit and receive channels (a MIMO radar), that is conducting a search function. The radar therefore transmits M orthogonal waveforms from M different antennas. Each waveform is Tp seconds long, and the radar listens for a period of Ts before transmitting the next pulse (see FIG. 7). Therefore, the communication transmitter may transmit L communication symbols, where L≤Ts/Tp−1. For each of the L communication symbols, the method uses a spatial constraint matrix to form a virtual spatial signature. This virtual signature, when processed by the radar, makes the communication signal appear as if it is coming from another direction. Therefore, the radar will naturally cancel out the communication using spatial beamforming, and perform a search in the angular sector that the radar would normally be blind to. Further, the communication transmitter can form a number of virtual spatial signatures, Q, equal to the number of antennas minus 1 (Q=M−1). Therefore, the communication transmitter can use the selection of the virtual spatial signature as an information bearing choice. As such, the communication transmitter can achieve data rates on the order of kilobits to megabits per second depending on radar system parameters.

FIG. 6 illustrates the block diagram for uplink signal transmission in a dual-function radar communication system. We assume that the uplink user is equipped with a single antenna. The uplink system simultaneously transmits Q communication symbols within a time duration lTₚ≤t≤(l+1)Tₚ, where Tₚ is the radar pulse width. The source coding block maps the source binary information bits into the coded symbols Ω_{q,l}, q=1, . . . ,Q, l=1, . . . , L. Each symbol Ω_{q,l} is multiplied to the corresponding transmit weight vector u_{q}. The orthogonal waveform generation block generates the same set of orthogonal waveforms used by the MIMO radar system. The modulation block is used to produce Q modulated signals ψ_{q,l}(t), q=1, . . . , Q. The modulated signals can be modeled as

ψ_{q,l}(t)=Ω_{q,l}u_{q}^{T}Ø(t)=Ω_{q,l}Σₘ₌₁^{M}u_{q,m}Øₘ(t), (25)

where M is the number of orthogonal waveforms, Ø=[Ø₁(t), . . . , Ø_{M}(t)]^{T} is the vector of orthogonal waveforms and u_{q,m} is the m-th entry of the vector u_{q}. The signal sₗ (t)=Σ_{q=1}^{Q}ψ_{q,l}(t) represents the uplink baseband signal that needs to be transmitted. After digital-to-analog conversion (DAC), the uplink signal is up converted to RF then fed to the transmitter.

FIG. 7 illustrates the block diagram for the MIMO radar receiver. The MIMO radar receiver simultaneously receives target returns (target signal) and uplink communication signals. Radar target returns can happen anywhere within the duration Tₚ≤t≤T_{PRI}, where T_{PRI} is the radar pulse repetition interval. Assuming time synchronization is established, the uplink communication signals impinge on the MIMO radar receive array within the time duration lTₚ≤t≤(l+1)Tₚ≤T_{PRI}, l=1, . . . , L. Note that the time duration 0≤t≤Tₚ is reserved for MIMO radar transmission, i.e., no uplink transmission takes place during that time. The MIMO radar receiver is equipped with N receive antennas. The received data is down converted to baseband then analog-to-digital conversion (ADC). The signal obtained from each receive antenna is then passed through a bank of M matched-filters. The outputs of all matched-filters are stacked in an NM×1 virtual data vector. Then, a radar beamformer block is used to extract the radar target signals from all other signals. In addition, Q communication beamformers are used to extract the data associated with each communication symbol. The output of each communication beamformer is then passed through a symbol detection block. Once, a symbol is detected, the receiver then proceeds to decode the corresponding binary data associated with that symbol.

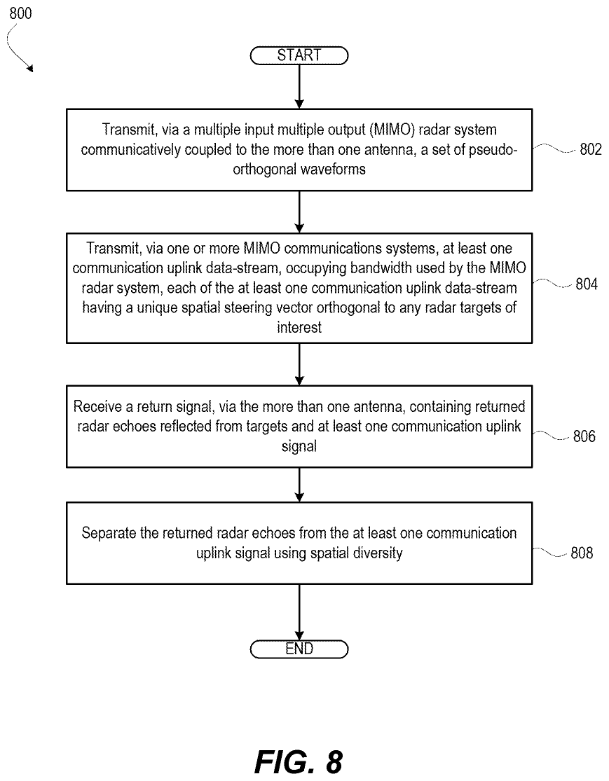

FIG. 8 presents a flow diagram of a method 800 for receiving radar returns and uplink communications using a dual-function radar communications (DFRC) system. Method 800 can be performed by an apparatus described in FIGS. 1-7. In one or more embodiments, method 800 includes transmitting, via a multiple input multiple output (MIMO) radar system communicatively coupled to the more than one antenna, a set of pseudo-orthogonal waveforms (block 802). Method 800 includes transmitting, via one or more MIMO communications systems, at least one communication uplink data-stream, occupying bandwidth used by the MIMO radar system (block 804). Each of the at least one communication uplink data-stream has a unique spatial steering vector orthogonal to any radar targets of interest. Method 800 includes receiving a return signal, via the more than one antenna, containing returned radar echoes reflected from targets and at least one communication uplink signal (block 806). Method 800 includes separating the returned radar echoes from the at least one communication uplink signal using spatial diversity (block 808). The method 800 ends.

In one or more embodiments, the more than one antenna are an array of collocated receive antennas of a MIMO radar receiver of the MIMO radar system. The at least one communication uplink signal is a selected communication uplink signal transmitted by a selected uplink communication transmitter in a first spatial direction. The returned radar echoes are reflections from a selected target located in the first spatial direction and simultaneously received with the selected communication uplink signal. Method 800 further includes separating the returned radar echoes from the selected communication uplink signal using minimum variance distortionless response (MVDR) beamforming.

In one or more embodiments, the at least one communication uplink signal is a plurality of unique uplink communication beams transmitted by an uplink communication source. Each unique uplink communication beam carries a respective one of plurality of communication symbols that comprise the set of pseudo-orthogonal waveforms. Method 800 further includes transferring the plurality of unique uplink communication beams simultaneously to a receiver of the MIMO communications system that separately receives each communication symbol. In one or more particular embodiments, the MIMO communications system includes more than one non-adaptive beamerformer that respectively receive the plurality of unique uplink communication beams and extract the corresponding communication symbol. In one or more specific embodiments, the more than one non-adaptive radar beamformer extract a desired target signal while rejecting interference from uplink communication signals arriving from the same direction as the target.

In one or more embodiments, method 800 further includes extracting a desired target signal from the returned radar echoes reflected from the desired target while rejecting interference from uplink communication signals arriving from a same direction as the desired target using a non-adaptive beamerformer.

In one or more embodiments, method 800 further includes extracting a desired target signal from the returned radar echoes reflected from the desired target while simultaneously rejecting interference from uplink communication signals arriving from a same direction as the desired target and maximally rejecting interference from radar signals arriving from spatial directions other than the direction of the desired target using an adaptive radar beamformer.

In the preceding detailed description of exemplary embodiments of the disclosure, specific exemplary embodiments in which the disclosure may be practiced are described in sufficient detail to enable those skilled in the art to practice the disclosed embodiments. For example, specific details such as specific method orders, structures, elements, and connections have been presented herein. However, it is to be understood that the specific details presented need not be utilized to practice embodiments of the present disclosure. It is also to be understood that other embodiments may be utilized and that logical, architectural, programmatic, mechanical, electrical and other changes may be made without departing from general scope of the disclosure. The following detailed description is, therefore, not to be taken in a limiting sense, and the scope of the present disclosure is defined by the appended claims and equivalents thereof.

References within the specification to “one embodiment,” “an embodiment,” “embodiments”, or “one or more embodiments” are intended to indicate that a particular feature, structure, or characteristic described in connection with the embodiment is included in at least one embodiment of the present disclosure. The appearance of such phrases in various places within the specification are not necessarily all referring to the same embodiment, nor are separate or alternative embodiments mutually exclusive of other embodiments. Further, various features are described which may be exhibited by some embodiments and not by others. Similarly, various requirements are described which may be requirements for some embodiments but not other embodiments.

It is understood that the use of specific component, device and/or parameter names and/or corresponding acronyms thereof, such as those of the executing utility, logic, and/or firmware described herein, are for example only and not meant to imply any limitations on the described embodiments. The embodiments may thus be described with different nomenclature and/or terminology utilized to describe the components, devices, parameters, methods and/or functions herein, without limitation. References to any specific protocol or proprietary name in describing one or more elements, features or concepts of the embodiments are provided solely as examples of one implementation, and such references do not limit the extension of the claimed embodiments to embodiments in which different element, feature, protocol, or concept names are utilized. Thus, each term utilized herein is to be given its broadest interpretation given the context in which that terms is utilized.

While the disclosure has been described with reference to exemplary embodiments, it will be understood by those skilled in the art that various changes may be made and equivalents may be substituted for elements thereof without departing from the scope of the disclosure. In addition, many modifications may be made to adapt a particular system, device or component thereof to the teachings of the disclosure without departing from the essential scope thereof. Therefore, it is intended that the disclosure not be limited to the particular embodiments disclosed for carrying out this disclosure, but that the disclosure will include all embodiments falling within the scope of the appended claims. Moreover, the use of the terms first, second, etc. do not denote any order or importance, but rather the terms first, second, etc. are used to distinguish one element from another.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The description of the present disclosure has been presented for purposes of illustration and description, but is not intended to be exhaustive or limited to the disclosure in the form disclosed. Many modifications and variations will be apparent to those of ordinary skill in the art without departing from the scope of the disclosure. The described embodiments were chosen and described in order to best explain the principles of the disclosure and the practical application, and to enable others of ordinary skill in the art to understand the disclosure for various embodiments with various modifications as are suited to the particular use contemplated.

What is claimed is:

1. A dual-function radar communications (DFRC) system comprising:
more than one antenna;
a multiple input multiple output (MIMO) radar system communicatively coupled to the more than one antenna;
at least one MIMO communications system communicatively coupled to the more than one antenna; and
a controller communicatively coupled to the MIMO radar system and the at least one MIMO communications system, the controller executing program code to enable the DFRC system to:
transmit, via the MIMO radar system, a set of pseudo-orthogonal waveforms;
transmit, via the at least one MIMO communications system, at least one communication uplink data-stream, occupying bandwidth used by the MIMO radar system, each of the at least one communication uplink data-stream carrying a same number of data symbols and having a unique spatial steering vector orthogonal to any radar targets of interest;
receive a return signal, via the more than one antenna, containing returned radar echoes reflected from targets and at least one communication uplink signal; and
separate the returned radar echoes from the at least one communication uplink signal using spatial diversity.

2. The DFRC system of claim 1, wherein:
the more than one antenna comprise an array of collocated receive antennas of a MIMO radar receiver of the MIMO radar system;
the at least one communication uplink signal comprises a selected communication uplink signal transmitted by a selected uplink communication transmitter in a first spatial direction;
the returned radar echoes comprise reflections from a selected target located in the first spatial direction and simultaneously received with the selected communication uplink signal; and
the controller executes the program code to enable the DFRC system to separate the returned radar echoes from the selected communication uplink signal using minimum variance distortionless response (MVDR) beamforming.

3. The DFRC system of claim 1, wherein:
the at least one communication uplink signal comprises a plurality of unique uplink communication beams transmitted by an uplink communication source, each unique uplink communication beam carrying a respective one of plurality of communication symbols that comprise the set of pseudo-orthogonal waveforms; and
the more than one antenna transfer the plurality of unique uplink communication beams simultaneously to a receiver of the MIMO communications system that separately receives each communication symbol.

4. The DFRC system of claim 3, wherein the MIMO communications system comprises more than one non-adaptive beamerformer that respectively receive the plurality of unique uplink communication beams and extract the corresponding communication symbol.

5. The DFRC system of claim 4, wherein the more than one non-adaptive radar beamformer extract a desired target signal while rejecting interference from uplink communication signals arriving from the same direction as the target.

6. The DFRC system of claim 1, comprising a non-adaptive beamerformer that extracts a desired target signal from a target while rejecting interference from uplink communication signals arriving from a same direction as the target.

7. The DFRC system of claim 1, further comprising an adaptive radar beamformer that extracts a desired target signal from a desired target while simultaneously rejecting interference from uplink communication signals arriving from a same direction as the desired target and maximally rejecting interference from radar signals arriving from spatial directions other than the direction of the desired target.

8. A method for receiving radar returns and uplink communications using a dual-function radar communications (DFRC) system, the method comprising:
transmitting, via a multiple input multiple output (MIMO) radar system communicatively coupled to the more than one antenna, a set of pseudo-orthogonal waveforms;
transmitting, via one or more MIMO communications systems, at least one communication uplink data-stream, occupying bandwidth used by the MIMO radar system, each of the at least one communication uplink data-stream carrying a same number of data symbols and having a unique spatial steering vector orthogonal to any radar targets of interest;
receiving a return signal, via the more than one antenna, containing returned radar echoes reflected from targets and at least one communication uplink signal; and
separating the returned radar echoes from the at least one communication uplink signal using spatial diversity.

9. The method of claim 8, wherein:
the more than one antenna comprise an array of collocated receive antennas of a MIMO radar receiver of the MIMO radar system;
the at least one communication uplink signal comprises a selected communication uplink signal transmitted by a selected uplink communication transmitter in a first spatial direction;
the returned radar echoes comprise reflections from a selected target located in the first spatial direction and simultaneously received with the selected communication uplink signal; and
to the method further comprising separating the returned radar echoes from the selected communication uplink signal using minimum variance distortionless response (MVDR) beamforming.

10. The method of claim 8, wherein the at least one communication uplink signal comprises a plurality of unique uplink communication beams transmitted by an uplink communication source, each unique uplink communication beam carrying a respective one of plurality of communication symbols that comprise the set of pseudo-orthogonal waveforms, the method further comprising transferring the plurality of unique uplink communication beams simultaneously to a receiver of the MIMO communications system that separately receives each communication symbol.

11. The method of claim 10, wherein the MIMO communications system comprises more than one non-adaptive beamerformer that respectively receive the plurality of unique uplink communication beams and extract the corresponding communication symbol.

12. The method of claim 11, wherein the more than one non-adaptive radar beamformer extract a desired target signal while rejecting interference from uplink communication signals arriving from the same direction as the target.

13. The method of claim 8, further comprising extracting a desired target signal from the returned radar echoes reflected from the desired target while rejecting interference from uplink communication signals arriving from a same direction as the desired target using a non-adaptive beamerformer.

14. The method of claim 8, further comprising extracting a desired target signal from the returned radar echoes reflected from the desired target while simultaneously rejecting interference from uplink communication signals arriving from a same direction as the desired target and maximally rejecting interference from radar signals arriving from spatial directions other than the direction of the desired target using an adaptive radar beamformer.
